(19) United States
(12) Patent Application Publication
(10) Pub. No.: US 2022/0371560 A1
(43) Pub. Date: Nov. 24, 2022

(54) SENSOR AND/OR CONTROL DEVICE AND METHOD FOR CREATING A PIECE OF DRIVER-CHARACTERIZING BRAKING AND/OR DRIVING STYLE INFORMATION FOR A DRIVER OF A VEHICLE

(71) Applicant: Robert Bosch GmbH, Stuttgart (DE)

(72) Inventor: Sebastian Schuler, Schwieberdingen (DE)

(21) Appl. No.: 17/744,147

(22) Filed: May 13, 2022

(30) Foreign Application Priority Data
May 19, 2021 (DE) 10 2021 205 092.1

(51) Int. Cl. B60T 8/1755; B60T 8/32; B60W 40/09; B60W 10/18; B60W 50/00

(52) U.S. Cl. CPC B60T 8/17555; B60T 8/3265; B60W 40/09; B60W 10/18; B60W 50/0098; B60T 2220/02; B60T 2220/04; B60W 2050/0088; B60W 2510/18; B60W 2540/30

(57) ABSTRACT

A sensor and/or control device for a vehicle. The sensor and/or control device includes an electronics unit configured to read out and/or establish during at least a single actuation of a brake actuation element of the vehicle by a driver of the vehicle, an adjustment travel of the brake actuation element, an adjustment speed of the brake actuation element and/or an adjustment acceleration of the brake actuation element, based on at least one signal provided to the electronics unit. The electronics unit configured to establish a temporal average and/or a temporal frequency distribution each of the adjustment travel of the brake actuation element, of the adjustment speeds of the brake actuation element and/or of the adjustment accelerations of the brake actuation element as at least part of a piece of driver-characterizing braking and/or driving style information.

### FIELD

The present invention relates to a sensor and/or control device for a vehicle and to a vehicle device for a vehicle for interacting with the sensor and/or control device. The present invention further relates to a method for creating a piece of driver-characterizing braking and/or driving style information for a driver of a vehicle and to a method for operating at least one vehicle device of a vehicle according to a driver-adapted operating mode.

### BACKGROUND INFORMATION

The related art such as, for example, German Patent Application No. DE 10 2019 210 269 A1, describes ascertaining an adjustment travel of the brake actuation element and an adjustment speed of the brake actuation element during an actuation of a brake actuation element by a driver of a vehicle and to take these into account when activating an electromechanical brake booster of the vehicle.

### SUMMARY

The present invention relates to a sensor and/or control device for a vehicle, to a vehicle device for a vehicle, to a method for creating a piece of driver-characterizing braking and/or driving style information for a driver of a vehicle, and to a method for operating at least one vehicle device of a vehicle according to a driver-adapted operating mode.

The present invention provides advantageous possibilities for creating a piece of driver-characterizing braking and/or driving style information for a driver of a vehicle in such a way that the created piece of driver-characterizing braking and/or driving style information corresponds to a “personal braking and/or driving profile” of the respective driver of the vehicle. The “personal braking and/or driving profile” of the driver may also be referred to as a “braking and/or driving fingerprint” of the driver. The piece of driver-characterizing braking and/or driving style information created with the aid of the present invention allows, in particular, for conclusions to be drawn about the personal braking and driving behavior of the respective driver. The piece of driver-characterizing braking and/or driving style information created according to the present invention thus defines an interface between the driver and his/her vehicle, on the basis of which it is not only apparent how a brake application/deceleration of a vehicle experienced as pleasant by a driver proceeds, but which also allows for conclusions to be drawn about further preferences of the driver during a drive of the vehicle. Thus, the piece of driver-characterizing braking and/or driving style created according to the present invention may be utilized in a versatile manner.

In one advantageous specific embodiment of the sensor and/or control device of the present invention, the electronics unit is additionally designed and/or programmed to store the established piece of driver-characterizing braking and/or driving style information on at least one mobile device predefined for the sensor and/or control device and/or on a data medium at least partially introduced into the sensor and/or control device. This enables the driver to rapidly and easily transfer the created piece of driver-characterizing braking and/or driving style information to a further vehicle.

Alternatively or in addition, in accordance with an example embodiment of the present invention, the electronics unit may also be designed and/or programmed, taking the established piece of driver-characterizing braking and/or driving style information into account, to create a wear prognosis, damage prognosis and/or service life prognosis in each case for at least one vehicle device of the vehicle. Whereas customarily only one previously effected load of at least the one vehicle device of the vehicle and its age are estimated for a prognosis of their further operability, a more exact wear prognosis, damage prognosis and/or service life prognosis may be developed with the aid of the specific embodiment of the sensor and/or control device described herein based on the inclusion of the established piece of driver-characterizing braking and/or driving style information.

As an advantageous refinement of the present invention, the electronics unit may additionally be designed and/or programmed, taking at least the established piece of driver-characterizing braking and/or driving style information into account, to activate at least one vehicle device of the vehicle and/or to establish one driver-specific setpoint operating mode each of at least the one vehicle device of the vehicle,. The piece of driver-characterizing braking and/or driving style information is advantageously suited for establishing the driver-specific setpoint operating mode of at least the one vehicle device of the vehicle in such a way that the established driver-specific setpoint operating mode corresponds to an operating mode preferred by the driver of the vehicle of at least the one vehicle device of the vehicle. As is evident based on the following description, a “personal braking and/or driving profile” of the respective driver of the vehicle may be ascertained with the aid of the specific embodiment of the sensor and/or control device described herein, on the basis of which the driver-specific operating mode preferred by the driver of at least the one vehicle device may be very precisely established. The piece of driver-characterizing braking and/or driving style information created according to the present invention thus represents a valuable piece of knowledge about the braking and/or driving mode of his/her vehicle personally preferred by the driver, which may be utilized in an advantageous and versatile manner.

In one particularly advantageous specific embodiment of the sensor and/or control device of the present invention, the electronics unit is designed and/or programmed, taking the established piece of driver-characterizing braking and/or driving style information into account, to select the driver-specific setpoint operating mode of at least the one vehicle device of the vehicle from a selection set including at least two operating modes selectable for at least the one vehicle device of the vehicle, and to activate and/or program at least the one vehicle device of the vehicle, while taking the driver-specific setpoint operating mode into account, in such a way that a later operating mode of at least the one vehicle device of the vehicle corresponds to the selected driver-specific setpoint operating mode. The specific embodiment of the sensor and/or control device described herein thus takes advantage of the fact that the piece of driver-characterizing braking and/or driving style information created according to the present invention allows for a very precise prediction regarding an operability of the at least one vehicle device of his/her vehicle preferred by the driver, and then controls/programs at least the one vehicle device of the vehicle in such a way that the operability of at least the one vehicle device of his/her vehicle is adapted to the preferences of the driver.

Similarly, the electronics unit may also be designed and/or programmed, taking the established piece of driver-characterizing braking and/or driving style information into account, to preselect at least one operating mode for at least the one vehicle device of the vehicle from a selection set including at least two operating modes selectable for at least the one vehicle device of the vehicle, if at least two operating modes are preselected for the at least one vehicle device of the vehicle taking the piece of driver-characterizing braking and/or driving style information into account, to prompt the driver via at least one display device and/or sound emitting device of his/her vehicle and/or of his/her at least one mobile device, to select the driver-specific setpoint operating mode for at least the one vehicle device of the vehicle from the preselected operating modes by actuating an input element of his/her vehicle and/or of his/her at least one mobile device, and to activate and/or to program at least the one vehicle device of the vehicle, taking the driver-specific setpoint operating mode into account, in such a way that that a later operating mode of at least the one vehicle device of the vehicle corresponds to the selected driver-specific setpoint operating mode. This also yields the advantages previously mentioned in the preceding paragraph.

Alternatively or in addition, in accordance with an example embodiment of the present invention, the electronics device may also be designed and/or programmed to ascertain deviations between a last established piece of driver-characterizing braking and/or driving style information and a previously established piece of driver-characterizing braking and/or driving style information, and, if necessary, to activate at least one braking device of the vehicle for bringing the vehicle to a standstill. The specific embodiment of the sensor and/or control device described herein allows for a “panic recognition,” for example, i.e., a recognizing of a panic of the driver due to an emergency braking situation previously noticed by him/her, and may then bring the vehicle comparatively quickly to a standstill with the aid of the activation of the at least one braking device of the vehicle. In addition, the specific embodiment of the sensor and/or control device described herein may also be used for “theft recognition” by recognizing a theft of the vehicle by a thief based on the ascertained deviations, so that by quickly bringing the vehicle to a standstill, the thief is successfully prevented from removing the vehicle from the place of the theft.

A vehicle device for a vehicle for interacting with such a sensor and/or control device ensures the above-described advantages, the vehicle device being capable of being a cruise control system, an automatic drive control system, an emergency braking system, an electromechanical brake booster situatable or situated upstream from a main brake cylinder of the vehicle, a motorized piston-cylinder device integratable or integrated into the braking system of the vehicle, a brake system pump, and/or a vehicle seat alignment system. The present invention is thus usable in a versatile manner. It is noted, however, that the examples of the vehicle device enumerated herein are not to be interpreted as exhaustive.

An implementation of a corresponding method for creating a piece of driver-characterizing braking and/or driving style information for a driver of a vehicle also yields the previously described advantages. It is noted that the method for creating a piece of driver-characterizing braking and/or driving style information for a driver of a vehicle according to the above-explained specific embodiment of the sensor and/or control device may be refined.

In addition, an implementation of a corresponding method for operating at least one vehicle device of a vehicle according to a driver-adapted operating mode also yields the above-explained advantages. It is expressly noted that the method for operating at least one vehicle device of a vehicle according to a driver-adapted operating mode according to the above-explained specific embodiments of the sensor and/or control device may also be refined.

### BRIEF DESCRIPTION OF THE DRAWINGS

Further features and advantages of the present invention are explained below with reference to the figures.

FIGS. 1A through 1D show a flowchart and coordinate systems for explaining one specific embodiment of the method of the present invention for creating a piece of driver-characterizing braking and/or driving style information for a driver of a vehicle.

FIGS. 2A through 2C schematically show representations and a coordinate system for explaining one specific embodiment of the sensor and/or control device of the present invention.

### DETAILED DESCRIPTION OF EXAMPLE EMBODIMENTS

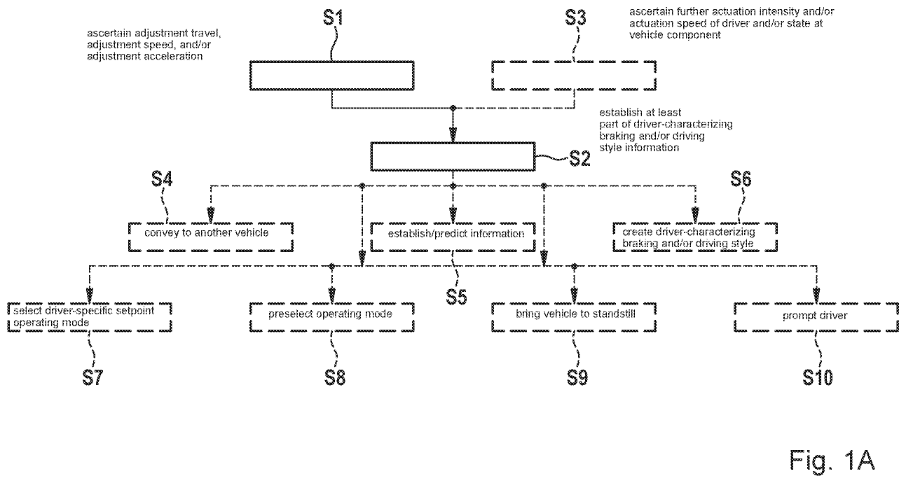

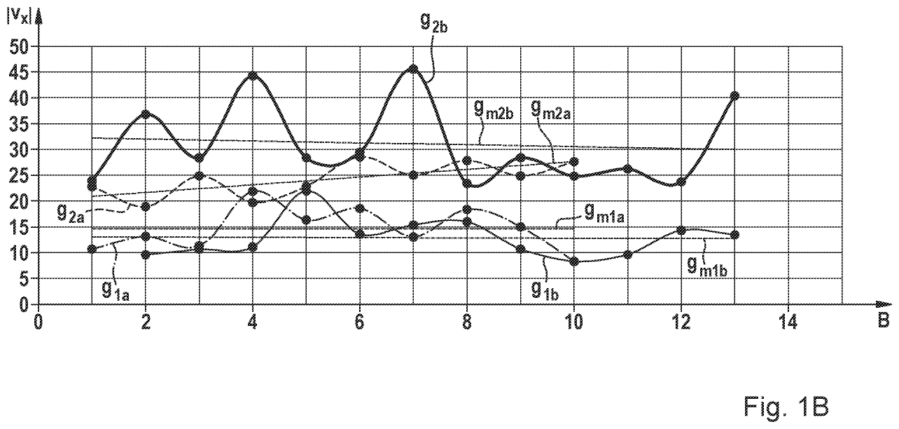

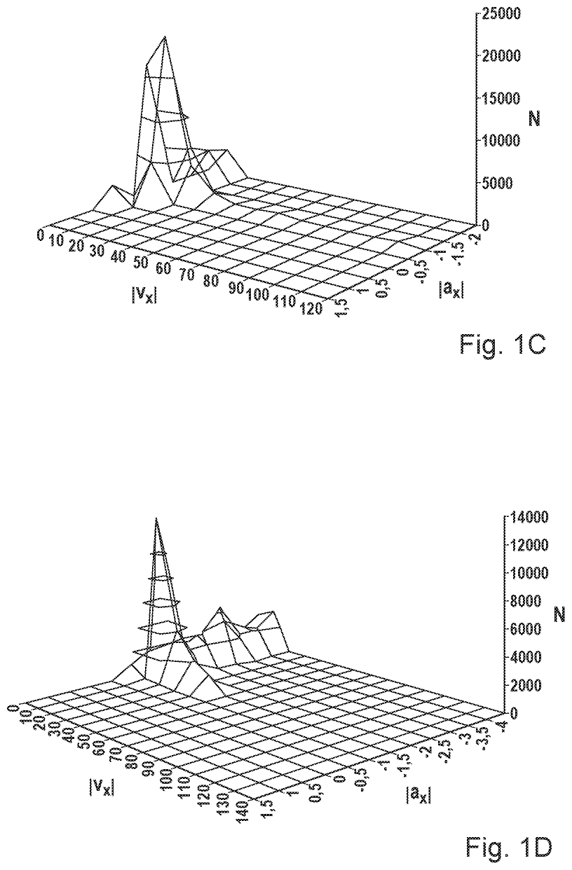

FIGS. 1A through 1D show a flowchart and coordinate systems for explaining one specific embodiment of the method for creating a piece of driver-characterizing braking and/or driving style information for a driver of a vehicle.

It is expressly noted that a feasibility of the method described below is not limited to any specific vehicle type/motor vehicle type of the respective vehicle.

The method includes a method step S1, which is repeatedly carried out by the driver during at least a single actuation of a brake actuation element of the vehicle. In method step S1, an adjustment travel x of the brake actuation element, an adjustment speed vₓ of the brake actuation element and/or an adjustment acceleration aₓ of the brake actuation element is/are ascertained. Method step S1 is preferably repeated during multiple actuations of the brake actuation element by the driver, in particular, while maintaining a predefined repetition frequency. The brake actuation element may, for example, be a brake pedal or a joystick.

In the coordinate system of FIG. 1B, an abscissa represents brake applications B of the vehicle, while an absolute value of adjustment speed vₓ of the brake actuation element (during actuation and release of the brake actuation element by the respective driver) is displayed with the aid of an ordinate of the coordinate system. A graph g₁ₐ represents the values for adjustment speed vₓ of the brake actuation element in the case of a conservative driving mode of a first driver, whereas a graph gib displays the corresponding values in the case of a sporty driving mode of the first driver. The values for adjustment speed vₓ of the brake actuation element in the case of a conservative driving mode of a second driver is read out from a graph g₂ₐ, whereas the corresponding values in the case of a sporty driving mode of the second driver are represented with the aid of a graph g_{2b}. For each of graphs g₁ₐ through g_{2b}, one straight line each gₘ₁ₐ ^{through g}_{m2b} with the smallest averaged deviation to the values of assigned graphs g₁ₐ through g_{2b} may be determined. Straight lines gₘ₁ₐ ^{through g}_{m2b} are also plotted into the coordinate system of FIG. 1B.

It is apparent based on a comparison of straight lines gₘ₁ₐ, through g_{m2b} that a maximum distance between straight lines gₘ₁ₐ and g_{m1b} of graphs g₁ₐ and g_{1b} of the first driver for all brake applications B is shorter than a respective minimal distance of straight lines gₘ₁ₐ, and g_{m1b} to straight lines g₂ₐ, and g_{m2b} of graphs g₂ₐ, and g_{2b} of the second driver. It is also noticeable that straight lines gₘ₂ₐ, and g_{m2b} of graphs of g₂ₐ, and g_{2b} for the second driver for all brake applications B have higher absolute values of adjustment speed vₓ of the brake actuation element than straight lines gₘ₁ₐ, and g_{m1b}of graphs g₁ₐ and g_{1b} for the first driver. Based on the comparison of straight lines gₘ₁ₐ through g_{m2b} it is thus apparent that the absolute value of adjustment speed vₓ of the brake actuation element for each of the two drivers remains relatively constant within a comparatively small tolerance band, even in the case of intentionally different driving modes of the respective driver. A temporal average (of the absolute value) of adjustment speed vₓ of the brake actuation element is thus a “personal braking and/or driving profile” or a “braking and/or driving fingerprint” of the respective driver, which barely changes even with a change of the driving mode of the respective driver between a conservative driving mode and a sporty driving mode.

The axes of the coordinate systems of FIG. 1C and 1D each represent the absolute value of adjustment speed vₓ of the brake actuation element, an absolute value of adjustment acceleration aₓ of the brake actuation element and a frequency N during brake applications B. The corresponding values of the first driver are plotted in the coordinate system of FIG. 1C, whereas the corresponding values for the second driver are displayed in the coordinate system of FIG. 1D. It is apparent based on a comparison of the frequency distributions of the coordinate system of FIG. 1C and 1D that each of the frequency distributions of FIG. 1C and 1D may also be interpreted as a “personal braking and/or driving profile” or as a “braking and/or driving fingerprint” of the first or second driver.

The method described herein therefore also has a method step S2, in which one temporal average each and/or one temporal frequency distribution of ascertained adjustment travel x of the brake actuation element, of ascertained adjustment speed vₓ of the brake actuation element and/or of ascertained adjustment accelerations aₓ of the brake actuation element is/are established as at least part of the piece of driver-characterizing braking and/or driving style information. As is apparent based on the coordinate systems of FIG. 1B through 1D and explained above, the piece of driver-characterizing braking and/or driving style information established in method step S2 may be interpreted as a “personal braking and/or driving profile” or as a “braking and/or driving fingerprint” of the respective driver. Such an established piece of driver-characterizing braking and/or driving style information may be utilized in a versatile and advantageous manner, as is evident based on the following description.

Method step S1 repeatedly carried out for establishing the piece of driver-characterizing braking and/or driving style information may be selectively carried out during an actuation of the brake actuation element by the driver, during a release of the brake actuation element by the driver or during an actuation of the brake actuation element and a release of the brake actuation element by the driver. A deceleration of the vehicle is particularly suited for repeatedly carrying out method step S1, since tests have shown that in this braking phase, a “personal braking and/or driving profile” or a “braking and/or driving fingerprint” of the respective driver may be ascertained with a high degree of reproducibility.

When evaluating brake applications B in method step S1, at least one surroundings sensor of the vehicle, one weather information system and/or one positioning system such as, for example, a global positioning system (GPS), may also be used, in order to ascertain adjustment travel x of the brake actuation element, adjustment speed vₓ of the brake actuation element and/or adjustment acceleration aₓ of the brake actuation element as a response of the driver to a particular surroundings situation, to a specific weather situation and/or to a particular vehicle position. Surroundings data, weather data and/or position data obtained in this way provide an indication of how the driver responds to particular surroundings situations, weather situations and/or traffic situations and thus advantageously contribute to the ascertainment of a personal driving style or of preferences of the driver. For example, it may be examined in this way how quickly and/or how strongly the driver brakes in a particular roadway gradient, in a particular curvature of a curve, in a particular traffic density, in rain, in snow, in icy conditions, close to a construction site, within a built-up area, on a country road and/or on a highway.

Optionally, a method step S3 may also be repeatedly carried out during at least one brake application B and/or during at least one drive of the vehicle, in which at least one further actuation intensity and/or actuation speed of the driver during actuations of at least one further actuation element of the vehicle and/or at least one state at at least one vehicle component of the vehicle is/are ascertained. The at least one further actuation element of the vehicle may, for example, be a steering of the vehicle and/or a gas pedal of the vehicle. The at least one state may, in particular, be determined to be at least one temperature at the at least one vehicle component of the vehicle and/or at least one brake pressure in at least one wheel brake cylinder of the vehicle. A sensor system for carrying out method step S3 for the examples of the at least one further actuation element and of the at least one state at the at least one vehicle component cited herein is already present in most vehicle types. If method step S3 is repeatedly carried out, a temporal average and/or a temporal frequency distribution of the at least one actuation intensity and/or actuation speed and/or of the at least one state, respectively, may also be established in method step S2 as part of the piece of driver-characterizing braking and/or driving style information. In this way, it is possible to create an even more complete image/model of the “personal braking and/or driving profile” or of the “braking and/or driving fingerprint” of the respective driver.

As an optional method step S4, the piece of driver-characterizing braking and/or driving style information established in method step S2 may be conveyed by the vehicle of the driver with the established piece of driver-characterizing braking and/or driving style information via a vehicle-to-vehicle communication to at least one further vehicle in the surroundings. The at least one further vehicle may subsequently adapt/synchronize its driving mode to the vehicle driven by the driver with the established piece of driver-characterizing braking and/or driving style information in such a way that a good traffic flow is continually ensured, in particular, a risk of accidents is reduced.

In one further optional method step S5, a piece of power consumption information and/or pollutant emission information, a road tax and/or an insurance class of the vehicle/of its driver with the established piece of driver-characterizing braking and/or driving style information may also be established/predicted, taking the established piece of driver-characterizing braking and/or driving style information into account. Based on the established piece of driver-characterizing braking and/or driving style information, it is possible to reliably predict a probable power consumption and/or a probable pollutant emission of the vehicle for a predefined driving distance and/or for a predefined time interval. The established piece of power consumption and/or pollutant emission information may then be conveyed to the driver via at least one display device and/or sound-emitting device of his/her vehicle and/or of at least one mobile device of the driver, as a result of which the driver may be prompted to drive in a more energy-saving and/or lower emissions-producing manner. If, based on the established piece of driver-characterizing braking and/or driving style information, it is apparent that the driver consumes only relatively little power and/or causes only comparatively low pollutant emissions, such as carbon dioxide and/or brake dust, due to his/her personal braking and/or driving style, a situation-related establishment of the road tax and/or of the insurance class for the driver are, in particular, advantageous.

Optionally, after method step S2, a wear prognosis, damage prognosis and/or service life prognosis in each case for at least one vehicle device of the vehicle of the driver with the established piece of driver-characterizing braking and/or driving style information may also be created as method step S6, taking the established piece of driver-characterizing braking and/or driving style information into account. The created wear prognosis, damage prognosis and/or service life prognosis of at least the one vehicle device of the vehicle may then be conveyed to the driver via the at least one display device and/or sound-emitting device of his/her vehicle and/or of his/her at least one mobile device. Alternatively or in addition, the created wear prognosis, damage prognosis and/or service life prognosis of at least the one vehicle device of the vehicle may also be transmitted to a repair shop. Because the personal driving style and the preferences of the driver reliably indicate future probable loads of the at least one vehicle device, the piece of driver-characterizing braking and/or driving style information established in method step S2 allows for a reliable early recognition or prediction of a component failure or of a wear at at least the one vehicle device of the vehicle. With the aid of the piece of driver-characterizing braking and/or driving style information, it is possible to prognosticate, in particular, earlier, when a visit of the vehicle to a repair shop becomes necessary, so that it is no longer necessary to await the actual occurrence of an emergency situation triggered by a component failure or a wear. In particular, a wear at at least one brake lining of the vehicle and/or a change of a brake friction coefficient (cp value) at a wheel brake cylinder may be predicted in a timely manner with the aid of the piece of driver-characterizing braking and/or driving style information established in method step S2.

The method described herein may, in particular, be part of a method for operating at least one vehicle device of a vehicle according to a driver-adapted operating mode. In this case, after the creation of the piece of driver-characterizing braking and/or driving style information for the driver of the vehicle by carrying out at least method steps S1 and S2, at least the one vehicle device of the vehicle is activated taking at least the created piece of driver-characterizing braking and/or driving style information into account, and/or one driver-specific setpoint operating mode each of the at least one vehicle device of the vehicle is established taking at least the created piece of driver-characterizing braking and/or driving style information into account. This is explained in greater detail below based on several examples:

In a method step S7, the driver-specific setpoint operating mode of at least the one vehicle device of the vehicle is preferably selected from a selection set including at least two operating modes selectable for at least the one vehicle device of the vehicle, while taking the piece of driver-characterizing braking and/or driving style information into account. At least the one vehicle device of the vehicle is subsequently activated and/or programmed, taking the selected driver-specific setpoint operating mode into account, in such a way that a later operating mode of at least the one vehicle device of the vehicle corresponds to the selected driver-specific setpoint operating mode. Method step S7 thus takes advantage of the fact that due to the establishment of the piece of driver-characterizing braking and/or driving style information, the “personal braking and/or driving profile” or the “braking and/or driving fingerprint” is/are known, and thus reliable predictions regarding the setpoint operating mode of at least the one vehicle device of the vehicle preferred by the driver are possible. The later operating mode of at least the one vehicle device of the vehicle may thus be easily adapted to individual requirements and preferences of the respective driver. This improves a braking and driving comfort for the driver during a further drive of his/her vehicle. This may also be described to the effect that when utilizing the method described herein, at least the one vehicle device of the vehicle “learns” the personal driving style and preferences of the driver, and in terms of its operability, adapts itself to the personal driving style and to the preferences of the driver.

Alternatively, at least one operating mode for at least the one vehicle device of the vehicle may, taking the piece of driver-characterizing braking and/or driving style information into account, also be preselected in a method step S8 from a selection set including at least two operating modes selectable for at least the one vehicle device of the vehicle. If at least two operating modes for at least the one vehicle device of the vehicle are preselected, taking the piece of driver-characterizing braking and/or driving style information into account, the driver may be prompted via the at least one display device and/or sound-emitting device of his/her vehicle and/or of his/her at least one mobile device, to select the driver-specific setpoint operating mode for at least the one vehicle device of the vehicle from the preselected operating modes by actuating an input element of his/her vehicle and/or of his/her at least one mobile device. At least the one vehicle device of the vehicle is subsequently controlled and/or programmed, taking the selected driver-specific setpoint operating mode into account, in such a way that a later operating mode of the least one vehicle device of the vehicle corresponds to the selected driver-specific setpoint operating mode.

In method steps S7 and S8, the at least one operating mode of at least the one vehicle device of the vehicle selected or preselected may be chosen, taking the piece of driver-characterizing braking and/or driving style information into account, from the selection set, in particular, in such a way that a possible later operation of at least the one vehicle device of the vehicle corresponding to the respectively selected or preselected operating mode requires only a comparatively low power consumption or results in a relatively low pollutant emission. For example, at least one operating mode of at least one braking device of the vehicle selected or preselected, may be chosen, taking the piece of driver-characterizing braking and/or driving style information into account, in such a way that a later implementation of the respectively selected or preselected operating mode by the at least one braking device results in a distribution of the braking force during later brake applications B of the vehicle, which is advantageous not only with respect to vehicle safety and braking comfort, but also with respect to power saving and/or emissions saving.

Method steps S4 through S6 explained above may also be carried out after the implementation of at least one of method steps S7 and S8. If appropriate, the selected driver-specific setpoint operating mode for at least the one vehicle device of the vehicle together with the piece of driver-characterizing braking and/or driving style information may be transmitted (method step S4) by the vehicle via a vehicle-to-vehicle communication to at least one further vehicle in the surroundings, the piece of power consumption and/or pollutant emission information, the road tax and/or the insurance class of the vehicle/of its driver may be established (method step S5) taking the selected driver-specific setpoint operating mode for at least the one vehicle device of the vehicle additionally into account, and/or the wear prognosis, damage prognosis and/or service life prognosis for at least the one vehicle device of the vehicle may be ascertained (method step S6) taking the selected driver-specific setpoint operating mode for at least the one vehicle device of the vehicle additionally into account.

Method step S2 may also be repeated or continuously carried out after waiting a predefined waiting time. If, during repetition of the method step, deviations between a last established piece of driver-characterizing and/or driving style information and a previously established piece of driver-characterizing and/or driving style information are established, one of method steps S9 or S10 may be carried out. If it is estimated that the deviations are attributable to the fact that the driver suddenly notices a potential accident risk, at least the one braking device of the vehicle is preferably activated as further method step S9 to bring the vehicle to a standstill. Optionally, safety measures such as, for example, pre-crash safety measures may also be started in method step S9 in order to limit the effects of a possible collision of the vehicle with a foreign object.

The deviations may, however, be due to the fact that the present driver of the vehicle has changed, for example, because a thief has stolen the vehicle. Thus, after recognition of the deviations between the last established piece of driver-characterizing braking and/or driving style information and the previously established piece of driver-characterizing braking and/or driving style information, the present driver of the vehicle may be prompted as further method step S10 via the at least one display device and/or sound-emitting device of his/her vehicle and/or of his/her at least one mobile device to identify his/her driving authorization by actuating the respective input element or by submitting a voice sample and/or, in particular, if the present driver of the vehicle fails to carry out a correct driving authorization identification, at least the one braking device of the vehicle may be activated to bring the vehicle to a standstill.

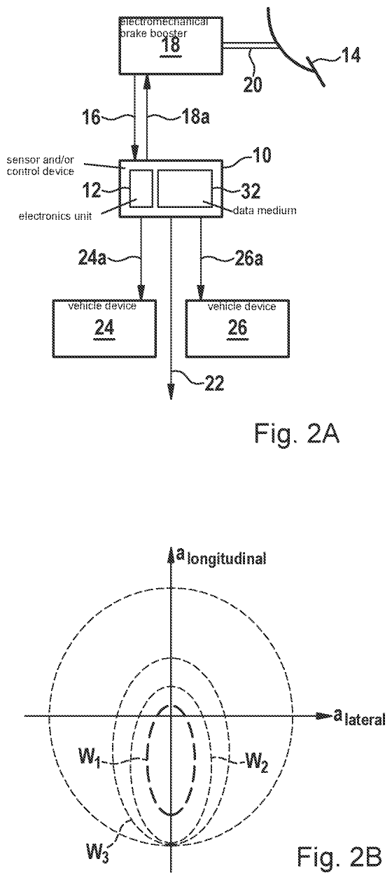

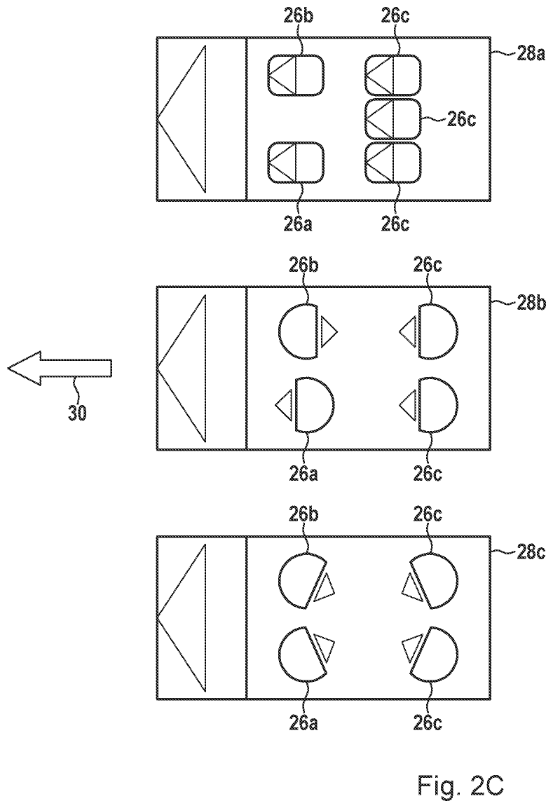

FIGS. 2A through 2C schematically show representations and a coordinate system for explaining one specific embodiment of the sensor and/or control device. A usability of sensor and/or control device 10 schematically represented in FIG. 2A is not limited to any specific vehicle type/motor vehicle type of the vehicle/motor vehicle (not shown) equipped therewith.

Sensor and/or control device 10 has an electronics unit 12, which is designed and/or programmed to read out and/or to establish during at least one actuation of a brake actuation element 14 of the vehicle by a driver of the vehicle, based on at least one provided signal 16, an adjustment travel of brake actuation element 14, an adjustment speed of brake actuation element 14 and/or an adjustment acceleration of brake actuation element 14. The adjustment travel of brake actuation element 14 may be understood to mean a path of brake actuation element 14 from its starting position. A starting position of brake actuation element 14 may refer to a position, in which brake actuation element 14 is present during a non-actuation by the driver of the vehicle. Brake actuation element 14 may, for example, be a brake pedal 14. Alternatively, brake actuation element 14 may, however, also be a joystick.

The at least one signal 16 may, in particular, be output by an electromechanical brake booster 18 to sensor and/or control device 10/to its electronics unit 12. Electromechanical brake booster 18 may be understood to mean a brake booster, such as, specifically, an iBooster situated upstream from a main brake cylinder (not shown). Such an electromechanical brake booster 18 is frequently already mounted on a vehicle/motor vehicle, and is suitable for reliably detecting the adjustment travel of brake actuation element 14 such as, in particular, for detecting a rod path of an input rod 20 connected at brake actuation element 14. Based on the adjustment travel of brake actuation element 14, it is then possible to derive the adjustment speed of brake actuation element 14 and/or the adjustment acceleration of brake actuation element 14.

Electronics unit 12 is also designed/programmed to establish in each case a temporal average and/or a temporal frequency distribution of the adjustment travels of brake actuation element 14, of the adjustment speeds of brake actuation element 14 and/or of the adjustment accelerations of brake actuation element 14 as at least part of a piece of a driver-characterizing braking and/or driving style information. As previously explained above, the piece of driver-characterizing braking and/or driving style information established with the aid of electronics unit 12 is suitable as a “personal braking and/or driving profile” or as a “braking and/or driving fingerprint” of the driver, which may be utilized in a versatile manner.

As a refinement not visually represented, at least one surroundings sensor of the vehicle, a weather information system and/or a positioning system such as, for example, a global positioning system (GPS), may also be used by electronics unit 12, in order to ascertain the adjustment travel of brake actuation element 14, the adjustment speed of brake actuation element 14 and/or the adjustment acceleration of brake actuation element 14 as a response of the driver to a particular surroundings situation, to a specific weather situation and/or to a particular vehicle position. Similarly, at least one further actuation force and/or actuation speed of the driver during at least one brake application and/or at least one drive of the vehicle when actuating at least one further actuation element of the vehicle and/or at least one state at at least one vehicle component of the vehicle may also be ascertained by electronics unit 12, and may also be taken into account when establishing the piece of driver-characterizing braking and/or driving style information by determining its temporal average and/or its temporal frequency distribution. All data enumerated herein indicate which braking style and/or driving style the driver of the vehicle experiences as pleasant.

For example, electronics unit 12 may be designed and/or programmed, after establishing the piece of driver-characterizing braking and/or driving style information, to create a wear prognosis, damage prognosis and/or service life prognosis in each case for at least one vehicle device of the vehicle, taking the established piece of driver-characterizing braking and/or driving style information into account.

Alternatively, a piece of power consumption and/or pollutant emission information, a road tax and/or an insurance class of the vehicle/of its driver may be predictable with the aid of electronics unit 12, taking the established piece of driver-characterizing braking and/or driving style information into account. At least one display device and/or sound-emitting device of the vehicle and/or of at least one mobile device of the driver may, in particular, be activatable with the aid of at least one information output signal 22 of electronics unit 12 for conveying the established wear prognosis, damage prognosis and/or service life prognosis, the established piece of power consumption information and/or pollutant emission information, the established road tax and/or the established insurance class to the driver and/or to a repair shop.

Electronics unit 12 is preferably also designed and/or programmed, taking at least the established piece of driver-characterizing braking and/or driving style information into account, to activate at least one vehicle device 18, 24, 26 of the vehicle, and/or to establish one driver-specific setpoint operating mode each of at least the one vehicle device 18, 24, 26 of the vehicle.

In the example of FIGS. 2A through 2C, electronics unit 12 is designed and/or programmed, in particular, taking the established piece of driver-characterizing braking and/or driving style information into account, to select the driver-specific setpoint operating mode of at least the one vehicle device 18 and 24 of the vehicle from a selection set including at least two operating modes selectable for at least the one vehicle device 18 and 24 of the vehicle. With the aid of at least one control signal 18a and 24a of electronics unit 12, the at least one vehicle device 18 and 24 of the vehicle is then activatable/programmable, taking the driver-specific setpoint operating mode into account, in such a way that a respective operating mode of at least the one vehicle device 18 and 24 of the vehicle corresponds to the selected driver-specific setpoint operating mode. For example, a rod path/brake pressure characteristic curve of electromechanical brake booster 18 and/or a jump-in range of electromechanical brake booster 18 may be selected by electronics unit 12 corresponding to the established piece of driver-characterizing braking and/or driving style information, and electromechanical brake booster 18 may then be programmed/activated accordingly.

For example, an automatic drive control system 24, i.e., an automatic system for autonomous (driverless) driving of the vehicle, as at least the one vehicle device 24 of the vehicle, is also influenceable in its operability with the aid of electronics unit 12 of FIGS. 2A through 2C. As is visually represented based on the coordinate system of FIG. 2B, automatic drive control system 24 is designed to decelerate the vehicle during an autonomous driving of the vehicle in an autonomous/driverless manner in such a way that a ratio between an instantaneous lateral acceleration aₗₐₜₑᵣₐₗ and an instantaneous longitudinal acceleration a_{longitudinal} lies within a predefined value range W₁ through W₃. Electronics unit 12 is thus advantageously designed/programmed, after establishment of the piece of driver-characterizing braking and/or driving style information, to select one of value ranges W₁ through W₃ as the setpoint value range to be maintained by automatic drive control system 24 and to then activate/to program automatic drive control system 24 with the aid of the at least one control signal 24a to maintain the established setpoint value range. The braking behavior of the autonomously driving vehicle thus corresponds to an individually preferred braking profile of the driver. In this way, the interaction of sensor and/or control device 10 with automatic driver control system 24 ensures that the braking behavior of the autonomously driving vehicle is adapted to the personal driving style and to the preferences of the driver. An interaction of sensor and/or control device 10 with automatic drive control system 24 is, however, not limited to a deceleration control. For example, an acceleration control of automatic drive control system 24 by sensor and/or control device 10, taking the piece of driver-characterizing braking and/or driving style information into account, may also be adapted to the personal driving style and to the preferences of the driver in such a way that the acceleration of the vehicle is also comfortably designed for the driver.

In addition, electronics unit 12 in the example of FIGS. 2A through 2C is also designed and/or programmed, taking the established piece of driver-characterizing braking and/or driving style information into account, to preselect at least one operating mode for at least the one vehicle device 26 of the vehicle from a selection set including at least two operating modes selectable for at least the one vehicle device 26 of the vehicle. If at least two operating modes are preselected for at least the one vehicle device 26 of the vehicle, taking the piece of driver-characterizing braking and/or driving style information into account, electronics unit 12 is designed/programmed, by outputting the at least one information output signal 22, to prompt the driver via the at least one display device and/or sound-emitting device of his/her vehicle and/or of his/her at least one mobile device by actuating an input element of his/her vehicle and/or of his/her at least one mobile device to select the driver-specific setpoint operating mode for at least the one vehicle device 26 of the vehicle from the preselected operating modes. At least the one vehicle device 26 of the vehicle is then controllable/programmable with the aid of at least one control signal 26a of electronics unit 12, taking the driver-specific setpoint operating mode into account, in such a way that a respective operating mode of at least the one vehicle device 26 of the vehicle corresponds to the selected driver-specific setpoint operating mode.

Vehicle device 26 is, for example, a vehicle seat alignment system 26, with the aid of which an alignment of a driver's seat 26a, a front passenger seat 26b and/or at least one rear seat 26c of the vehicle is/are adjustable. As is apparent on a vehicle 28a of FIG. 2C, all vehicle seats 26a through 26c may be aligned in such a way that a person sitting on each faces driving direction 30. In the example of a vehicle 28b of FIG. 2C, however, front passenger seat 26b is repositioned by 180° in such a way that a front seat passenger sitting thereon faces opposite driving direction 30. Such a seat alignment of front passenger seat 26b may be advantageous if the front seat passenger wishes to engage with at least one person sitting on the at least one rear set 26c, in particular, if the front seat passenger wishes to entertain at least one child sitting on the at least one rear seat 26c. In contrast, all seats 26a through 26c in a vehicle 28c of FIG. 2C are aligned in such a way that they are aligned to a central point located between seats 26a through 26c. Thus, taking the driver-specific setpoint operating mode into account, the driver may be provided recommendations with respect to an alignment of seats 26a through 26c of the vehicle harmonizing with the driving style of his/her automatic drive control system 24 during an autonomous drive, from which the driver then selects the alignment he/she personally prefers.

Alternatively or in addition, the vehicle device may also be an automatic drive control system for the autonomous driving of the vehicle, which provides the driver multiple driving styles for the autonomous drive of his/her vehicle based on the established piece of driver-characterizing braking and/or driving style information, such as, for example, a “sporty driving style” (“experiential mode”) and a “comfortable driving style” (such as, specifically for consuming a meal), from which the driver then selects the driving style to be executed by the automatic drive control system.

In addition, electronics unit 12 may also be designed and/or programmed to ascertain deviations between a last established piece of driver-characterizing braking and/or driving style information and a previously established piece of driver-characterizing braking and/or driving style information and, if necessary, to activate at least one braking device 18 of the vehicle for bringing the vehicle to a standstill. In addition or alternatively to electromechanical brake booster 18, integratable/integrated into the braking system of the vehicle, an emergency braking system, a motorized piston-cylinder device and/or a brake system pump as the at least one braking device 18 may be correspondingly activatable with the aid of electronics unit 12.

The sensor and/or control device 10/its electronics unit 12 may be designed, in particular, for carrying out all above-explained method steps. Electronics unit 12 is advantageously also designed and/or programmed to store the established piece of driver-characterizing braking and/or driving style information on at least one mobile device predefined for sensor and/or control device 10 and/or on a data medium 32 at least partially introduced into sensor and/or control device 10. Data medium 32 may, for example, be a USB stick. The driver may utilize the piece of driver-characterizing braking and/or driving style information also for a drive with another vehicle by transferring the piece of driver-characterizing braking and/or driving style information from the at least one mobile device or from data medium 32 to a controller of the other vehicle. This ensures that the other vehicle “adapts” very quickly to the driver, and thus no familiarization of the driver with the other vehicle utilized only temporarily is necessary. The established piece of driver-characterizing braking and/or driving style information may be utilized in this way also for car sharing, picking up a rental car and/or or for a taxi ride.

1-10 (canceled).

11. A sensor and/or control device for a vehicle, comprising:
an electronics unit configured to read out and/or to establish, during at least a single actuation of a brake actuation element of the vehicle by a driver of the vehicle, an adjustment travel of the brake actuation element, and/or an adjustment speed of the brake actuation element and/or an adjustment acceleration of the brake actuation element, based on at least one signal provided to the electronics unit, and the electronics unit also being configured to establish a temporal average and/or a temporal frequency distribution of: adjustment travel of the brake actuation element, and/or of adjustment speeds of the brake actuation element and/or of adjustment accelerations of the brake actuation element, as at least part of a piece of a driver-characterizing braking and/or driving style information.

12. The sensor and/or control device as recited in claim 11, wherein the electronics unit is also configured to store the established piece of driver-characterizing braking and/or driving style information on: (i) at least one mobile device predefined for the sensor and/or control device, and/or (ii) on a data medium at least partially introduced into the sensor and/or control device.

13. The sensor and/or control device as recited in claim 11, wherein the electronics unit is additionally configured to, taking the established piece of driver-characterizing braking and/or driving style information into account, create a wear prognosis, and/or damage prognosis and/or service life prognosis for each of at least one vehicle device of the vehicle.

14. The sensor and/or control device as recited in claim 11, wherein the electronics unit is also configured to, taking at least the established piece of driver-characterizing braking and/or driving style information into account, activate at least one vehicle device of the vehicle and/or establish a driver-specific setpoint operating mode of each of at least the one vehicle device of the vehicle.

15. The sensor and/or control device as recited in claim 14, wherein the electronics unit is also configured to, taking the established piece of driver-characterizing braking and/or driving style information into account, select the driver-specific setpoint operating mode of at least the one vehicle device of the vehicle from a selection set including at least two operating modes selectable for at least the one vehicle device of the vehicle, and activate and/or program at least the one vehicle device of the vehicle, taking the driver-specific setpoint operating mode into account, in such a way that a later operating mode of at least the one vehicle device of the vehicle corresponds to the selected driver-specific setpoint operating mode.

16. The sensor and/or control device as recited in claim 14, wherein the electronics unit is additionally configured to, taking the established piece of driver-specific braking style and/or driving style information into account, preselect at least one operating mode for the at least one vehicle device of the vehicle from a selection set including at least two operating modes selectable for the at least one vehicle device of the vehicle, and when at least two operating modes are preselected for the at least one vehicle device of the vehicle, taking the piece of driver-characterizing braking and/or driving style information into account, prompt the driver, via at least one display device and/or sound emitting device of the vehicle and/or of at least one mobile device of the driver, to select the driver-specific setpoint operating mode for at least the one vehicle device of the vehicle from the preselected operating modes by actuating an input element of the vehicle and/or of the at least one mobile device, and to activate and/or to program at least the one vehicle device of the vehicle, taking the driver-specific setpoint operating mode into account, in such a way that a later operating mode of at least the one vehicle device of the vehicle corresponds to the selected driver-specific setpoint operating mode.

17. The sensor and/or control device as recited in claim 14, wherein the electronics unit is additionally configured to ascertain deviations between a last established piece of driver-characterizing braking and/or driving style information and a previously established piece of driver-characterizing braking and/or driving style information.

18. The sensor and/or control device as recited in claim 17, wherein the electronics unit is additionally configured to activate at least one braking device of the vehicle for bringing the vehicle to a standstill, based on the ascertained deviations.

19. A vehicle device for a vehicle for interacting with a sensor and/or control device, the sensor and/or control device including an electronics unit configured to read out and/or to establish, during at least a single actuation of a brake actuation element of the vehicle by a driver of the vehicle, an adjustment travel of the brake actuation element, and/or an adjustment speed of the brake actuation element and/or an adjustment acceleration of the brake actuation element, based on at least one signal provided to the electronics unit, and the electronics unit also being configured to establish a temporal average and/or a temporal frequency distribution of: adjustment travel of the brake actuation element, and/or of adjustment speeds of the brake actuation element and/or of adjustment accelerations of the brake actuation element, as at least part of a piece of a driver-characterizing braking and/or driving style information, and the electronics unit is also configured to, taking at least the established piece of driver-characterizing braking and/or driving style information into account, activate a vehicle device of the vehicle and/or establish a driver-specific setpoint operating mode of each of the vehicle device of the vehicle, the vehicle device being a cruise control system, and/or an automatic drive control system, and/or an emergency braking system, and/or an electromechanical brake booster situatable or situated upstream from a main brake cylinder of the vehicle, and/or a motorized piston-cylinder device integratable or integrated into the braking system of the vehicle, and/or a brake system pump, and/or a vehicle seat alignment system.

20. A method for creating a piece of driver-characterizing braking and/or driving style information for a driver of a vehicle, the method comprising the following steps:
